(19) United States
(12) Patent Application Publication
(10) Pub. No.: US 2002/0081180 A1
(43) Pub. Date: Jun. 27, 2002

(54) Method for processing, in particular reading, programming, or such, card-shaped information carriers

(76) Inventor: Anders Berndtsson, Stein am Rhein (CH)

Correspondence Address: KENYON & KENYON, ONE BROADWAY, NEW YORK, NY, 10004, US

(21) Appl. No.: 10/026,982

(22) Filed: Dec. 18, 2001

(30) Foreign Application Priority Data
Dec. 19, 2000 (DE) 100 63 313.7

(51) Int. Cl. B65F 9/00

(52) U.S. Cl. 414/333

(57) ABSTRACT

A method, employing a device for processing, in particular for reading, programming or the like, of cards which are provided with an integrated circuit, chip or the like having at least one memory, the cards being conveyed along a path to at least one station where they are individually held fast by respective holding devices, provided with contactors, of a rotating carrier, and are processed during the rotational movement of the carrier, starting out from a device, by way of the contactors, and, subsequently thereto, the cards again being released by the holding devices onto the path. The individual cards are grasped by the holding device in question by the pressure action of a medium, in particular by suction action, and are held fast thereto.

### FIELD OF THE INVENTION

The present invention relates to a method for processing, in particular reading, programming, or such, card-shaped information carriers.

In addition, the present invention relates to a device for processing, in particular reading, programming, or such, card-shaped information carriers.

### BACKGROUND INFORMATION

Once manufactured, card-shaped information carriers of this kind are personalized. In this connection, the data associated with the particular cardholder are programmed on the card. In the case of credit cards, this data can include, for example, account numbers, addresses, and the like. Current efforts are directed to programming as much information as possible on the card, for example, even to combining information otherwise stored on several different cards, such as identification information, including social security information and bank information, on one card, to enable the cardholder to only carry one card with him/her.

To program, in particular to personalize the individual cards, the contacts of the contact surface of the card's chip are connected to a computer system. In a special processing mode, the data are transmitted from the computer to the chip on the card.

Normally, the cards are not programmed, e.g., personalized by the issuer of the cards, but rather by the service provider, who distributes the cards to cardholders and then has the task of personalizing a multiplicity of cards. For various known reasons, the processing, in particular reading, programming, or such, of the mentioned cards requires a certain amount of time. Present-day demands require writing an ever increasing amount of data on the mentioned cards. This can result in a bottleneck when the cards are personalized, which is why the fastest possible processing speeds are needed.

A method and a device of the aforementioned type are described in French Published Patent Application No. 27 66 945, where a roughly drum-shaped carrier equipped with individual holding devices is driven about an axis which runs substantially in parallel to the path and, in this context, substantially in parallel next to the transport direction of the path, so that the path is directed more or less tangentially, but more or less in parallel to the drum's axis of rotation. The individual holding devices are designed to form an interspace in which the path and the cards transported thereon are accommodated, so that when a card arrives in the interspace, it is grasped by forces of the holding device directed transversely thereto and is moved rotationally out of the path region. During rotation of the drum-shaped carrier, a card is processed and is subsequently transferred to the path again. A considerable drawback of this known method and device is that, in the process, the cards are decelerated in their movement and are subsequently accelerated again. A complicated clamping mechanism is used to remove the cards from the path and to hold them. The individual components and the mechanics of such a device are complicated and expensive. The method permits only relatively low processing speeds, indicated at 3,000 cards per hour.

### SUMMARY OF THE INVENTION

An object of the present invention is to devise a method of the type mentioned at the outset which will enable cards of this kind to be processed in simple fashion and at high speeds.

This object is achieved in accordance with the present invention in a method of the type mentioned at the outset.

The present invention is also directed to a device for processing, in particular reading, programming or such, card-shaped information carriers.

The method and the device according to the present invention are exceptionally simple. Simple, cost-effective components are used, the number of the individual components being reduced. Beneficial is that the individual cards are successively removed from the path and are processed, e.g., read or programmed during the movement, in particular one rotation of the carrier, and then, following a rotation, are again returned to the path, without the transport speed of the path being altered in the process. Since the at least one moving, in particular rotating, carrier is situated at the level of the path, above the same and oriented along the same, the cards are moved one after another in this vertical plane containing the path, thus substantially transversely to the surface of the cards, i.e., removed from the path and, following rotation of the carrier, are again delivered in an opposite direction to the path, without any movement of the cards transversely to the path. Considerable speeds of, for example, up to 50,000 cards per hour may be reached for processing the cards. In this connection, there is no possible danger of malfunctions.

### BRIEF DESCRIPTION OF THE DRAWINGS

FIG. 1 shows a schematic plan view of a card-shaped information carrier.

FIG. 2 shows a schematic, part-sectional side view of parts of a device for processing such card-shaped information carriers.

FIG. 3 shows a schematic, part-sectional side view, on a larger scale, of a detail of the device for processing card-shaped information carriers.

FIG. 4 shows a schematic, part-sectional side view of a part of a holding device of the device.

FIG. 5 shows a view in arrow direction V in FIG. 3, including a partial section of details of the device.

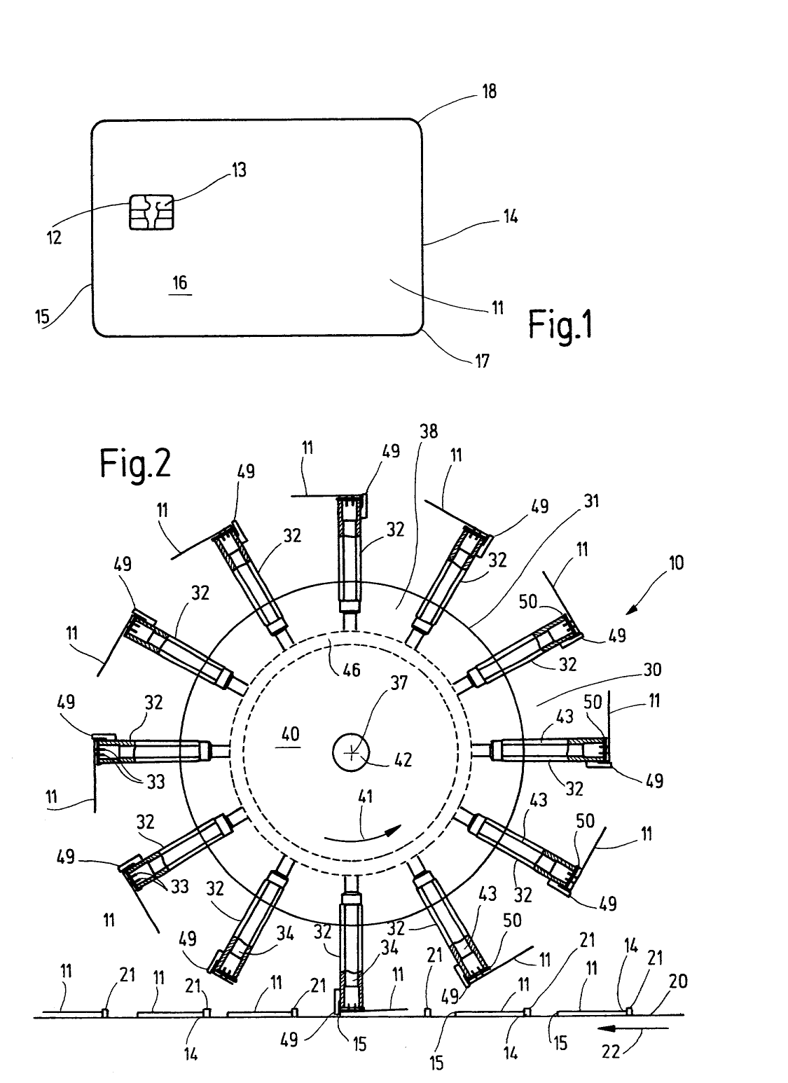

### DETAILED DESCRIPTION

Schematically shown in the drawings is a part of a device 10 of interest here, which is generally used for processing, in particular for reading, programming or the like, of card-shaped information carriers, such as of check cards, credit cards, identification cards, or the like, cards 11. In accordance with FIG. 1, cards 11 of this kind are provided with an integrated circuit, chip or the like, which has at least one memory and is generally denoted by 12, and which has a top-side contact surface 13 including individual contacts. Contact surface 13 may have a plurality of individual contacts, up to eight or ten contacts, which, for processing, in particular reading, programming or such, are contacted by contactors, which are then connected, in turn, to a computer system and a current source. The processing of such cards 11, in particular the reading, programming, or such, is generally known and, therefore, does not need to be described in further detail. What is required of such devices 10, especially in view of the escalating quantities of data which need to be processed in connection with such cards 11, in particular which need to be read and/or programmed, is that they render possible a highest possible speed for processing cards 11, speeds of up to 50,000 cards per hour, or even higher, being desirable.

Device 10 has a path, generally denoted by 20, in the form of a conveyance system having entrainer mechanisms 21 for transporting the cards in arrow direction 22. This path 20 in the form of a conveyance system has, for example, at least one chain, which bears entrainer mechanisms 21 and on which cards 11 rest and are transported in the forward arrow direction 22, with one edge 14 abutting on each entrainer mechanism 21. This conveyance system may also have at least one band. Each entrainer mechanism 21 is composed of a lug or the like.

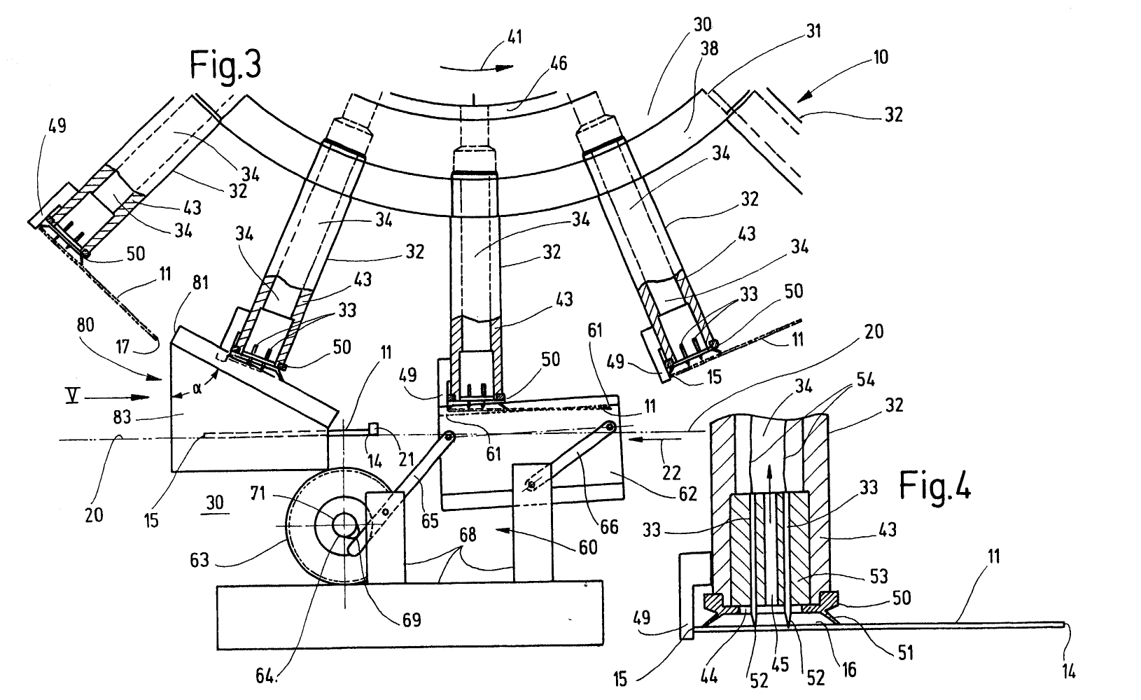

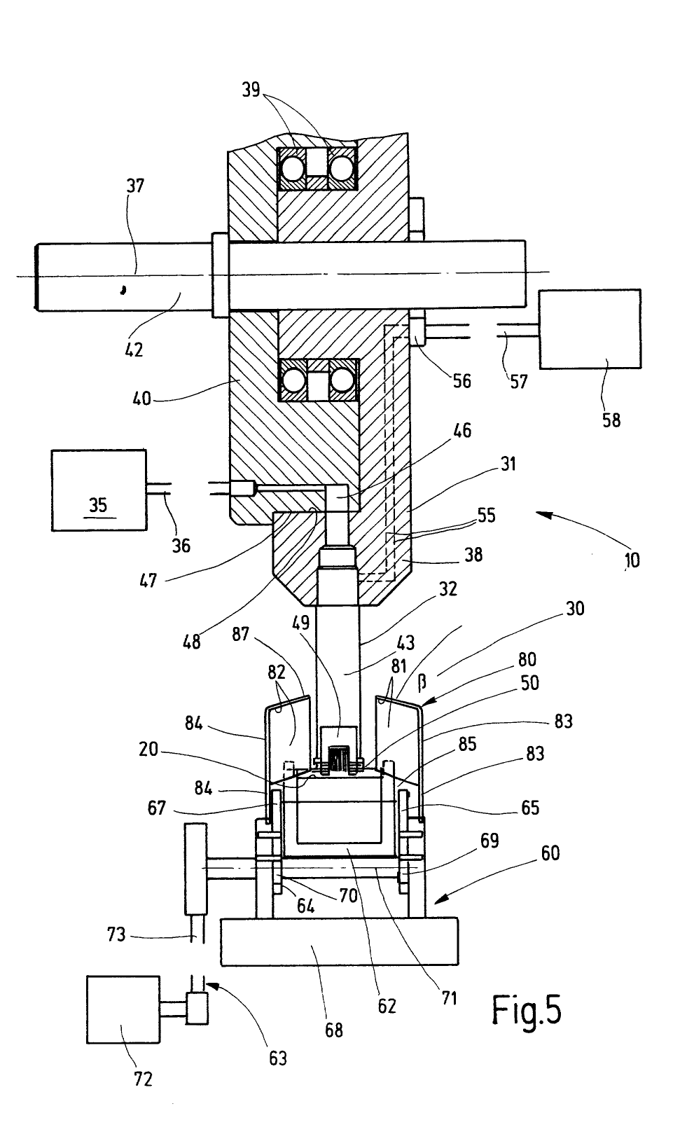

As is especially apparent from FIGS. 3 and 5, device 10 has at least one station 30 in the vicinity of path 20. It is understood, however, that in the transport direction in accordance with arrow 22 of path 20, a plurality of similarly designed stations 30 may also be configured one behind the other, of which, for example, one or more stations 30 are used for reading the memories of individual cards 11, and other stations following at a distance in the transport direction according to arrow 22, are used analogously to station 30, to program the memory of individual cards 11. In this case, the processing speed may be multiplied, in the case of two stations 30, e.g., doubled. In this context, the interim time in which cards 11 are brought from first station 30 to the next station, may be utilized for farther processing steps, e.g., for checking a code key read out in the first station from the particular memory of cards 11, by comparing it to another code key, which is integrated, for example, in a computer that controls the reading system.

Even when it is not specially illustrated, another design is also possible instead, in which a plurality of preferably similarly designed stations are configured next to one another, transversely to the transport direction in accordance with arrow 22 of path 20, these stations being movable by transverse motion into the region of path 20 in the card-pick-up position and the card-release position, respectively, and of which, for example, one station 30 or also a plurality of stations being provided for reading the memories of cards 11 in question, and other stations being used for programming the memories of cards 11 in question.

The depicted station 30 has a driven carrier 31 including a plurality of holding devices 32, each holding device 32 being provided with individual contactors 33, merely two of these being shown for the sake of clarity. In the illustrated exemplary embodiment, altogether 12 holding devices 32 of the same kind are mounted on carrier 31. Each holding device 32 is used for grasping and holding fast each assigned card 11 during the moving phase of carrier 31, in which the processing of the memories of cards 11 takes place, and is used for the subsequent releasing to path 20. Individual holding devices 32 each have a pressure or suction device 34, which works using the pressure of a medium, in particular gas, e.g., air, and, in this context, in the design as a pressure device, works with high pressure and, in the alternative design as a suction device, works with low pressure, with the assistance of the mentioned pressure or suction-device 34, individual cards 11 being able to be grasped and held fast by the pressure action of the medium, in particular by its suction force. In the illustrated exemplary embodiment, each holding device 32 is provided with a suction device 34 that works with a partial vacuum. Individual cards 11 are grasped and held fast by the partial vacuum of the gaseous medium, e.g., air, by the suction of this suction device. If, instead, a pressure device 34 is provided, individual cards 11 are grasped and held fast by this, in response to the pressing action of the high pressure of the gaseous medium, e.g., air. In both cases, when grasped and held by their contact surfaces 13, individual cards 11 are brought, at the same time, into electrically conductive contact with contactors 33 and held fast, so that, in this time, cards 11 may be processed, e.g., read or programmed. Once processing in station 30 is complete, individual cards 11 are then again released by individual holding devices 32 to path 20, which may be accomplished mechanically, for example, in the still to be described manner. In place of or in support of this, individual cards 11, held by suction to holding devices 32, may also be released, following the processing, by a high pressure of the gaseous medium, e.g., air, by being blown away from holding devices 32 onto path 20.

Individual holding devices 32 are conceived such that the medium acting upon individual cards 11, in particular the partial-vacuum medium used for suctioning, is directed through the particular holding devices 32 to cards 11, the medium acting upon cards 11 and, in fact, suctioning the same, being supplied to carrier 31 via a line 36 from a central supply unit 35 having a partial-vacuum source (indicated only schematically in FIG. 5).

The at least one carrier 31, having individual holding devices 32, which are each provided with contactors 33, is rotatable about an axis 37, running substantially in parallel to path 20 and, in this context, transversely thereto, in particular substantially perpendicularly thereto. In the process, this at least one carrier 31 rotates with the individual holding devices 32 having contactors 33, above path 20 and, in this context, within a plane disposed at least substantially in a vertical alignment with path 20.

The at least one carrier 31 has a disk 38, which is rotationally mounted via bearings 39 on a central supporting part 40 about the mentioned axis 37. In this context, disk 38 is able to be rotationally propelled by a driving device (not shown further) about mentioned axis 37 and, in fact, preferably in the direction of rotation according to arrow 41, oppositely to the forward transport movement of the path in accordance with arrow 22. Part of the driving device is, for example, a shaft 42, to which disk 38 is rotatably fixed and on which an electromotor (not shown further), works, if needed, by way of an intermediate gear, such as a driving belt. The configuration can be set up such that the processing of one card, picked up by a holding device 32, is concluded after one rotation of carrier 31, in particular of disk 38. The diameter of the at least one carrier 31, in particular of disk 38, and/or its rotational speed, and/or the number of holding devices 32, disposed at approximately the same angular distances along the periphery and having contactors 33, may be selected and varied in accordance with a predefined processing capacity.

The individual holding devices 32 are made of essentially radial arms 43, which are designed, for example, as individual pipes, and which have a respective suction device 34, such that each arm 43 has an inner hollow space, which forms an inner pressurized-media channel 34, which leads to the unattached end 44 of arm 43 and, there, opens out into at least one opening 45, via which, by the action of a partial vacuum in inner channel 34 on a card 11, a suction action is exerted such that card 11, in this manner, is constantly held fast and in an aligned position at end 44 of arm 43. The inner pressurized-media channel 34 of each arm 43 forming the suction device is connected at the other end, facing away from opening 45, to a circumferential, annular groove 46, which is contained in outer peripheral area 47 of support part 40 upon which disk 38 having an inner peripheral area 48 rotates, so that pressurized-media channels 34, e.g., boreholes in disk 38, are continually connected, during their rotation, to annular groove 46. Consequently, each arm 43 is continually supplied via annular groove 46 with a partial vacuum. Central supply unit 35 and, in general, the partial-vacuum supply of individual holding devices 32 are devised such that the partial vacuum supplied to individual arms 43 is regulated in such a way that it suffices to retain card 11, given only one holding device 32 receiving a card 11 at end 44, which closes opening 45 there in response to suction, even when openings 45 in question of all remaining holding devices 32, which have not picked up and do not hold any card 11, are not closed, resulting thereby in a lowering of the partial vacuum.

Each holding device 32, in particular each arm 43, bears laterally at end 44 for card 11 in question, a transversely running limit stop 49, which, when a card 11 is received, is used to align it such that card 11 comes up against limit stop 49 with its front edge 15 and, in this manner, remains aligned.

Each holding device 32, in particular each arm 43, has at end 44 which contains opening 45, a sealing device 50 surrounding this opening 45. Sealing device 50 is advantageously elastic. It has, for example, a rubber apron, generally denoted by 51, a rubber lip, a bellows or the like, which, in response to the suctioning of a card 11, under the action of the partial vacuum, positions itself elastically and, in this context, at least essentially sealingly against the facing top side 16 of card 11. The elastic characteristics of sealing device 50 not only result in a reliable sealing action in response to the suctioning action, but in a tolerance adjustment as well.

Each holding device 32, in particular each arm 43, has individual contact pins 52, which are held in its hollow inner space, as contactors 33, which project with their rounded or pointed ends so far out of end-side opening 45 that they, when holding one card 11 in each instance, are forced by the partial vacuum into and retained in electrically conductive contact with contact surface 13, and, in the process, each individual contact pin 52 with the particular assigned contact of contact surface 13. It can be advantageous when contactors 33, in particular contact pins 52, have resilient ends. Contact pins 52 are surrounded by insulation material 53 and connected to electric lines 54 (only indicated in FIG. 4), which are led through the hollow inner space of holding device 32 in question, and which are used for supplying current and/or as information lines. Individual lines 54 are connected to lines 55 (only hinted at) at disk 38, which lead, for example, to an only schematically indicated rotational transformer 56 of carrier 31, which, for its part, is connected via lines 57 to an only schematically indicated unit 58, which is preferably used for the central supplying of current and/or information.

The at least one station 30 has a transfer device 60, which is active between path 20 and a holding device 32 of carrier 31 arriving, at any one time, in its area. With the assistance of transfer device 60, a card 11 is able to be lifted up from path 20 and brought to a transfer position, where it is able to be retrieved by a free holding device 32, in particular an arm 43, moving past, by the suction action. In the process, card 11 is forced by transfer device 60 into a transfer position, that is inclined with respect to the plane of path 20, e.g., with respect to a horizontal. This inclination is only indicated in FIG. 3 by the oblique line, denoted by 61. The oblique profile of diagonal lines 61 is such that they rise at least slightly in the direction of rotation according to arrow 41 and, respectively, oppositely to the transport direction of path 20 according to arrow 22. Clearly, the transfer position is not horizontal and, thus, also not at right angles to the longitudinal central axis of a holding device 32, in particular of an arm 43, but rather at least slightly inclined, in accordance with diagonal line 61, so that when an arm 43 moves past, the transfer of a card 11, which is lifted up by transfer device 60 from the path, to arm 43 takes place somewhat later. Thus, individual cards 11 are lifted up from path 20 by transfer device 60 and brought into a transfer position corresponding to diagonal line 61, where they are then taken over by suction device 34 of a holding device 32, in particular of an arm 43, by the action of suction.

Transfer device 60 has a lifting member 62, which is mounted underneath path 20 and is able to be driven in controllable fashion in such a way that lifting member 62 is able to grasp a card 11 transported on path 20, from underneath, and lift it over path 20. Lifting member 62 is able to be driven by a driving device 63 synchronously to the transport speed of path 20, drive device 63 having, for example, a curve control 64. Lifting member 62 is movably retained by two oblique guide rods 65, 66, mounted on one side, and by two guide rods mounted correspondingly on the other side. Of these, only guide rod 67 is visible in FIG. 5. Guide rods 65 through 67 grip at one end with a rotating motion on lifting member 62, which is held and moved in this manner. With their other end, guide rods 65 through 67 are pivoted on both sides on a holding device 68. Driving device 63 engages at least on one guide rod 67 located on a side of lifting member 62. In the depicted exemplary embodiment, the engagement takes place at both guide rods 65 and 67, which have, for example, a prolongation extending over their bottom articulated link at holding device 68, on which abuts a schematically indicated cam 69, 70, which is rotationally fixed to a shaft 71 of driving device 63 that is rotationally driven, for example, by a motor 72 having a belt drive 73 that likewise constitutes part of driving device 63. In response to rotation of shaft 71, lifting member 62 is moved in rocker-like fashion between a lower position where the lifting surface of lifting member 62 is situated, for the most part, completely underneath path 20, and an upper position, where the lifting surface has the profile of diagonal line 61.

The at least one station 30 has, in addition, a second transfer device 80, which, viewed in the transport direction of arrow 22, follows first transfer device 60 at a distance. Second transfer device 80 may be used to release a card 11 from a holding device 32 that is retaining it, preferably following one rotation of carrier 31, in particular of disk 38, and to return it to path 20.

In an exemplary embodiment (not shown), this second transfer device 80 may be designed and function similarly to first transfer device 60, and be configured in a mirror image thereto, individual cards 11, subjected to the suction action of holding devices 32, being released by a high pressure, blown off to the second transfer device, and again being transferred by this device to path 20.

In the second exemplary embodiment, second transfer device 80 is designed differently than first transfer device 60. It has two guide surfaces 81 and 82, disposed above path 20, transversely thereto, at a distance from one another, which slope in the direction of rotation of carrier 31, in particular of disk 38, in accordance with arrow 41, and oppositely to the forward transport movement in accordance with arrow 22 of path 20. Because of these sloping guide surfaces 81, 82, on both sides, in response to rotation of carrier 31, in particular of disk 38, a card 11, which is held at a holding device 32, in particular at an arm 43, may be pushed by its front, rounded corners 17, 18 on both sides, of its front edge 14, in each instance, onto an assigned guide surface 81, 82, in such a way that card 11 then, in response to a further rotational movement in arrow direction 41, is released by positive action from end 44 of arm 43, while overcoming the vacuum, and is transferred onto path 20 by falling onto the same. The diagonal profile which slopes down counter to the transport direction according to arrow 22 is indicated in FIG. 3 by angle α.

The two sloping guide surfaces 81, 82 run, moreover, with respect to a plane which runs in parallel to the plane of path 20 and which is horizontally aligned, for example, in FIG. 5, at an angle α, each sloping down from the inside toward the outside. Second transfer device 80 has a shaft 85, which is formed by shaft walls 83, 84 on both sides and which, at the top end region, has guide surfaces 81, 82, sloping on both sides. Path 20 runs between the two shaft walls 83, 84. The top edges of shaft walls 83, 84 facing away from path 20 have edge strips 86 and 87, sloping respectively in the direction of rotation of carrier 31 according to arrow 41, which are directed toward one another and each of whose sides pointing toward path 20 forms guide surface 81 and 82, respectively.

If during the transport movement in accordance with arrow 22, a card 11 being moved in the forward direction on path 20 arrives in the region of first transfer device 60 and of lifting member 62, then card 11 is lifted up at least slightly from path 20 and forced into inclined position 61, in response to the rotation of carrier 31, a holding device 32, which is unattached at end 44, in particular an arm 43, arriving at this point in the region of lifted card 11, which is suctioned by suction device 34 by partial vacuum at end 44, in particular in the region of sealing device 50, and is held fast in this manner, so that, in response to continued rotation of carrier 31 in arrow direction 41, card 11 is retained at arm 43. In the process, card 11 is aligned with its edge 15 over limit stop 49 and remains in this aligned position. In response to the suction action, contactors 33 having resilient contact pins 52 are pressed against assigned contacts of contact surface 13 of card 11 and held in this position. During one rotation of carrier 31, card 11 may be read, for example with respect to contained information, e.g., coding, in station 30, this process being concluded following one rotation. In place of this, the card may also be read and/or programmed during one rotation. Following one rotation, holding device 32 arrives, together with card 11, in the region of second transfer device 80, card 11 being driven in, with its comers 17, 18 at the front, into shaft 85 and, in the process, abutting with its comers 17, 18 on assigned guide surface 81 and 82, respectively, and being moved forward by displacement along guide surfaces 81, 82, oppositely to the transport direction in accordance with arrow 22, accompanied by the rotational movement of holding device 32. In the process, card 11 is moved away by its front end, in response to guided action, from sealing device 50 and end 44 of holding device 32, so that card 11 is, in a way, forcibly released, counter to the action of the partial vacuum, from sealing device 50 and end 44. Card 11 arrives on top side of path 20, and when entrainer mechanism 21 reaches edge 14, is entrained in the transport direction in accordance with arrow 22.

When device 10 has a plurality of stations analogous to station 30 and disposed one behind the other, then, during one rotation of carrier 31, individual cards 11 are read, for example, in the first station comparably to station 30, with respect to contained information, e.g., codings and, after that, are again released to path 20. In the time in which card 11 is fed to second and/or third analogous station 30 following in the transport direction according to arrow 22, code key read out from card 11 in first station 30 may be compared to another stored code key and decoded and, thus, in this manner, the interim time may be utilized. When card 11 then reaches the downstream, second analogous station 30, card 11 may then be programmed, e.g., personalized, in this station during one rotation of carrier 31.

Device 10 in accordance with the present invention has the advantage that the individual components are readily assembled, are light and inexpensive, have only a few parts and, already for that reason, permit rapid rotational speeds for carrier 31. The reading and/or programming of a card 11 takes place during the rotation of carrier 31, thereby saving time, so that, even when working with a rapid sequence of cards, a multitude of information may be read in the briefest of times and be written on card 11. The details described regarding device 10, which make it possible to pick up a card from the path, to hold it fast while contacting it, and to release it again to the path, are exceptionally simple, inexpensive and uncomplicated in their mechanical design. Device 10 makes it possible to process, in particular to read and/or program a large number of cards in a short period of time and, therefore, rapidly, speeds of, for example, 50,000 cards per hour, or even greater, being attainable. The danger of any malfunctions is ruled out.

What is claimed is:

1. A method for processing a card-shaped information carrier including a card provided with one of an integrated circuit and a chip that includes at least one memory, comprising the steps of:
conveying the card along a path to at least one station;
at the at least one station, causing a holding device of at least one driven carrier to individually grasp and hold fast the card, the holding device being provided with a contactor;
processing the card during a movement of the at least one driven carrier, starting out from a unit by way of the contactor; and
subsequently to the processing, releasing the card again by the holding device to the path, wherein:
the card is grasped and held fast by a pressure action of a medium.

2. The method according to claim 1, wherein:
the processing is for one of a reading operation and a programming operation.

3. The method according to claim 1, wherein:
the card includes one of a check card, a credit card, and an identification card.

4. The method according to claim 1, further comprising the step of:
when the card is grasped and held fast by the pressure action, bringing the card, at the same time, by a contact surface thereof, into an electrically conductive contact with the contactor.

5. The method according to claim 1, wherein:
the card is grasped and held fast by a high pressure of a gaseous medium in response to the pressure action.

6. The method according to claim 5, wherein:
the gaseous medium includes air.

7. The method according to claim 1, wherein:
the card is grasped and held fast by a partial vacuum of a gaseous medium in response to a suction action.

8. The method according to claim 7, wherein:
the gaseous medium includes air.

9. The method according to claim 1, wherein:
subsequent to the processing, the card is released to the path in response to a cessation of the pressure action.

10. The method according to claim 7, wherein:
subsequent to the processing, the card, individually held by suction, is released by being blown away onto the path in response to a high pressure of the gaseous medium.

11. The method according to claim 1, wherein:
subsequent to the processing, the card is mechanically released from the holding device and transferred to the path.

12. The method according to claim 1, further comprising the step of:
directing the medium through the holding device to the card, the medium including at least one of a partial-vacuum medium used for suctioning and a high-pressure medium used for blowing away.

13. The method according to claim 1, further comprising the step of:
causing a supply unit to supply the medium acting on the individual card to the at least one driven carrier.

14. The method according to claim 13, wherein:
the medium includes at least one of a partial-vacuum medium used for suctioning and a high-pressure medium used for blowing away.

15. The method according to claim 13, wherein:
the supply unit includes a partial-vacuum source.

16. The method according to claim 1, wherein:
the at least one driven carrier is rotatable.

17. The method according to claim 16, wherein:
the at least one driven carrier is rotatable about an axis, running substantially in parallel to the path and transversely thereto.

18. The method according to claim 17, wherein:
the axis runs substantially perpendicularly to the path.

19. The method according to claim 1, wherein:
the at least one driven carrier rotates above the path and within a plane disposed at least substantially in aligninent with the path.

20. The method according to claim 1, wherein:
the processing of the card is concluded following one rotation of the at least one driven carrier.

21. The method according to claim 1, wherein:
at least one of a diameter of the at least one driven carrier, a rotational speed of the at least one driven carrier, and a number of holding devices, disposed at angular distances along a periphery of the at least one driven carrier and having contactors, is selected in accordance with a predefined processing capacity.

22. The method according to claim 1, further comprising the step of:
causing a rotational transformer to transmit an electrical energy and information to the at least one driven carrier and individual contactors thereof.

23. The method according to claim 1, further comprising the step of:
transferring the card in the at least one station to the holding device in a transfer position corresponding to a diagonal line, where the card is lifted up from the path.

24. The method according to claim 23, wherein:
in the transfer position, the card extends in a plane which is inclined with respect to a plane of the path.

25. The method according to claim 1, further comprising the steps of:
before transferring the card to the holding device, causing a transfer device to take the card from the path; and
bringing the card to a transfer position corresponding to a diagonal line.

26. The method according to claim 25, wherein:
the card is taken from the path by being lifted off.

27. The method according to claim 1, further comprising the step of:
aligning the card at the holding device in a reproducible position using a limit stop.

28. The method according to claim 1, wherein:
the step of processing includes processing a plurality of cards one of one behind the other and next to each other in a plurality of stations.

29. The method according to claim 1, further comprising the steps of:
reading in the card at the at least one station with respect to contained information that includes codings; and
subsequently programming the card in a following second station.

30. The method according to claim 29, further comprising the step of:
after the card passes through the at least one station, releasing the card again to the path and causing the second station to pick up the card again from the path.

31. A device for processing a card-shaped information carrier including a card provided with one of an integrated circuit and a chip that includes at least one memory, comprising:
a path including a conveyance system for transporting the card;
at least one station arranged in a vicinity of the path and including at least one driven carrier, the at least one driven carrier including a plurality of holding devices, each one provided with contactors for grasping and holding fast the card during a moving phase of the at least one driven carrier; and
an arrangement for processing the card during a movement of the at least one driven carrier, wherein:
the holding device releases the card to the path, and
the holding device includes one of a pressure device and a suction device that works using a pressure of a medium and with whose assistance the card is able to be grasped and held fast by a pressure action of the medium.

32. The device according to claim 31, wherein:
the processing is for one of a reading operation and a programming operation.

33. The device according to claim 31, wherein:
the card includes one of a check card, a credit card, and an identification card.

34. The device according to claim 31, wherein:
the pressure action corresponds to a suction force.

35. The device according to claim 31, further comprising:
a central supply unit for supplying the one of the pressure device and the suction device with the medium.

36. The device according to claim 35, wherein:
the medium includes air that is under pressure corresponding to a partial vacuum.

37. The device according to claim 31, further comprising:
a driving device, wherein:
the at least one driven carrier includes a disk that is held rotatably about an axis running substantially in parallel to, transversely to, and above the path, and
the disk is able to be rotationally propelled about the axis by the driving device in a direction of rotation oppositely to a forward transport direction of the path.

38. The device according to claim 31, wherein:
the holding device includes radial arms disposed at approximately the same angular distances from one another on a disk of the at least one driven carrier, and
each radial arm includes a respective one of the pressure device and the suction device.

39. The method according to claim 38, wherein:
each radial arm includes an inner pressurized-media channel that leads to an unattached end of the respective radial arm and, there, opens out into at least one opening, via which, a pressure action, is exerted on the card, thereby holding the card at the unattached end of the respective radial arm.

40. The device according to claim 39, wherein:
the pressure action corresponds to a partial-vacuum action.

41. The device according to claim 39, further comprising: a central supply unit that includes a partial-vacuum source, wherein:
the inner pressurized-media channel of each radial arm is connected at another end, facing away from the at least one opening, to a circumferential, annular groove provided at a central support part bearing the disk, the circumferential, annular groove supplying each radial arm with a pressurized medium corresponding to a partial vacuum and being connected to the central supply unit.

42. The device according to claim 31, further comprising:
an elastic sealing arranged at an end of each arm of the holding device, the elastic sealing device surrounding at least one opening via which a pressure action is exerted on the card, wherein:
the elastic sealing includes one of a rubber apron, a rubber lip, and a bellows, and
against the elastic sealing rests in a sealing manner the card, the card being held at the arm under a pressure corresponding to a partial vacuum.

43. The device according to claim 41, wherein:
the partial-vacuum supplied by the central supply unit and fed to the holding device is regulated in such a way that the partial-vacuum suffices to retain the card given only one holding device receiving the card at the unattached end, the card closing the opening at the unattached end in response to suction, while any opening at an unattached end of other radial arms is not closed.

44. The device according to claim 39, wherein:
each radial arm bears at the unattached end, in each instance for one card, a transversely running limit stop.

45. The device according to claim 39, wherein:
each radial arm includes a contact pin held in an inner space as a contactor,
the contact pin projects with one of a rounded end and a pointed end thereof so far out of the at least one opening that the contact pin, when holding the card is forced into and retained in electrically conductive contact with a contact surface of the card.

46. The device according to claim 45, wherein:
the contact pin is resilient.

47. The device according to claim 45, wherein:
the contact pin is connected to an electric lines led through an inner space of the holding device, the electric line being used for at least one of supplying energy providing information.

48. The device according to claim 47, wherein:
the electric line is run to a rotational transformer of the at least one driven carrier that is connected to a unit for performing a central supplying of at least one of current and information.

49. The device according to claim 48, wherein:
the at least one station includes a first transfer device that is active between the path and the holding device, the transfer device lifting up the card from the path and bringing the card into a transfer position that is inclined with respect to a plane of the path, and
the holding device retrieves the card via an arm in response to a suction action.

50. The device according to claim 49, wherein:
the first transfer device includes a lifting member that is mounted underneath the path and is able to be driven in a controllable fashion in such a way that the lifting member is able to grasp the card when transported on the path, from underneath, and lift the card over the path.

51. The device according to claim 50, further comprising:
a driving device by which the lifting member is able to be driven synchronously to a transport speed of the path.

52. The device according to claim 50, wherein:
the lifting member is able to be driven by a curve control.

53. The device according to claim 50, further comprising:
two oblique guide rods by which the lifting member is movably retained, the two oblique guide rods being mounted on each side of the lifting member.

54. The device according to claim 51, wherein:
the driving device engages at least on one guide rod mounted on a side of the lifting member.

55. The device according to claim 49, wherein:
the at least one station includes a second transfer device disposed in a transport direction of the path at a distance from the first transfer device, the second transfer device being able to release the card from the holding device that is retaining the card following one rotation of the at least one driven carrier and then to return the card to the path.

56. The device according to claim 55, wherein:
the second transfer device is configured approximately in a mirror image to the first transfer device and is designed similarly thereto.

57. The device according to claim 55, wherein:
the second transfer device includes two guide surfaces disposed above the path and transversely thereto at a distance from one another,
the two guide surfaces slope in a direction of rotation of the at least one driven carrier and oppositely to a forward transport direction of the path, and
in response to a rotation of the at least one driven carrier, the two guide surfaces push the card held at the holding device by front corners thereof on both sides thereof, in such a way that the card, in response to a further rotational movement, is released from the unattached end of the holding device and is transferred onto the path.

58. The device according to claim 57, wherein:
the two guide surfaces run, with respect to a plane which runs substantially in parallel to the plane of the path, at an angle, each one of the two guide surfaces sloping from an inside toward an outside.

59. The device according to claim 58, wherein:
the second transfer device includes a shaft that at a top end region includes the two guide surfaces sloping down at another angle on both sides.

60. The device according to claim 59, wherein:
the shaft has, on both sides, shaft walls between which the path runs,
upper edges of the shaft walls facing away from the path have edge strips that slope in the direction of rotation of the at least one driven carrier, and
the edge strips are directed toward one another, each of whose sides pointing toward the path forms the two guide surface.

61. The device according to claim 31, further comprising:
a plurality of similarly designed stations arranged one behind the other in a transport direction of the path, wherein:
at least one of the plurality of similarly designed stations reads the at least one memory of the card, and
at least another of the plurality of similarly designed stations program the at least one memory of the card.

62. The device according to claim 31, further comprising:
a plurality of similarly designed stations arranged one behind the other transversely to a transport direction of the path, wherein:
the plurality of similarly designed stations are movable by transverse motion into a region of the path in a card pick-up position and a card-release position,
at least one of the plurality of similarly designed stations reads the at least one memory of the card, and
at least another of the plurality of similarly designed stations program the at least one memory of the card.
